(19) United States
(12) Patent Application Publication
(10) Pub. No.: US 2005/0225182 A1
(43) Pub. Date: Oct. 13, 2005

(54) Drive for the piston of a linear cooler

(76) Inventors: Andreas Fiedler, Erfstadt (DE); Gerd Flick, Bruhl (DE); Klaus Bergert, Troisdorf (DE)

Correspondence Address: Fay Sharpe Fagan;Minnich & McKee, Seventh Floor, 1100 Superior Avenue, Cleveland, OH, 44114-2518, US

(21) Appl. No.: 10/494,621

(22) PCT Filed: Aug. 17, 2002
(86) PCT No.: PCT/EP02/09226

§ 371 Date: Apr. 30, 2004

(30) Foreign Application Priority Data
Nov. 2, 2001 (DE) 10153-870.7

(51) Int. Cl. H02K 41/00; H02K 33/00

(52) U.S. Cl. 310/36; 310/12

(57) ABSTRACT

A drive for the piston of a linear cooler includes a magnet (6), a linear oscillation coil (3) and a power supply for the coil (3) with a flexible section of line (11) running from a fixed support component (1) to the oscillating coil (3). To increase its life-time, the line section (11) is either made from a bent strip of metal, preferably copper or a copper alloy, or from three components, a metal core, an insulating sheath surround the metal core and a support spring surrounding said sheath.

The invention relates to a drive for the piston of a linear cooler having the characteristics of patent claim 1.

Known linear coolers, for example Stirling coolers, consist of three components, a linear compressor, a cold finger and a helium-tight connection line. The design of the linear compressor is mirror-symmetrical. The oscillating components (pistons and coils) being implemented twice, move with respect to each other with a phase shift of 180°, resulting in low compressor vibrations and noise. The operating frequency is approximately 52 Hz. This corresponds to the frequency of resonance of the spring-mass system accommodated in the compressor housing. Resonance operation of the compressor is one significant reason for the comparatively high degree of efficiency of the Stirling linear cooler. The motor, consisting of a magnetic circuit with stationary magnets and moving coils is designed similar to the drive of loudspeakers. Flexible electrical feed lines serve the purpose of providing the current to the oscillating coils. The oscillating coils in the compressor and one or several displacers located in the cold finger are equipped with gap seals based on PTFE coated components. For the displacer drive, no motor or pneumatic piston is required. A helium gas flow produces, upon flowing through the regenerator integrated in the displacer, throttling forces which are employed for exciting the displacer oscillation. The centering springs within the compressor and the cold finger serve the purpose of stabilising the positions of the zero crossing of the oscillation and, moreover, define the amplitudes and phase positions of the oscillating displacers.

With linear coolers of the kind detailed, in particular Stirling coolers, temperatures especially in the range of 40 to 100 K can be produced with economically viable complexity. Military coolers, currently being the main application of the oscillating coil concept in Stirling coolers, are qualified for a life-time of 4000 hours. These chiefly serve the purpose of cooling infrared detectors in thermal imaging cameras. Coolers of this kind might also be employed for HTSC filters in mobile phone base stations. In applications of this kind, however, a cooler life-time of 4000 hours is not acceptable. Maintenance-free operation of 3 to 5 years must be achieved.

In experiments with coolers of the here affected kind it has been found time and again that the flexible line section(s) running from a fixed carrier to the oscillating coil is/are an important component limiting cooler life-time.

It is the task of the present invention to improve, in the instance of a drive for the piston of a linear cooler of the here affected kind, the power supply to the oscillating coil in view of reliability, current load rating, power loss and price.

This task is solved by the present invention through the characterising features of the patent claims.

In a first solution of the task (claims 1 to 8) the line section linking the fixed carrier component to the oscillating coil consists of a bent strip of metal, preferably copper or a copper alloy. A current feeder with a line section of this kind performs a defined movement, comparable to a rolling motion. Local displacements of the individual components and consequential tribologic effects do not occur. In that the design of the flexible line section is almost equivalent to the shape which would result if it were accelerated entirely without own stiffness, there result only very slight additional stresses due to the acceleration during the movement. The own mass of the line section can be maintained very low, whereby the acceleration forces are also kept low. Through long-term experiments it has been found that the risk of breakage is substantially reduced.

Since the line section consists of a simple and inexpensive strip, the current load rating is higher as well as power losses and costs are lower.

In the instance of a second solution of the task (claims 9 to 13) the line section between the fixed carrier and the oscillating coil consists of three components, a central core of an electrically conducting material, an insulating plastic sheath made of polytetrafluor ethylene (TEFLON) surrounding the core and a support component surrounding said sheath. These measures have the following beneficial effects:
Uniform bending of the cable across the entire cable length for preventing local overstraining (buckling) of the cable;
No impact (damage) of the cable insulation (made of Teflon, for example) with surrounding components;
No friction between the components of the cable;
Thermal stability;
Straining of the components within the range of the material's fatigue strength.

Moreover, this solution offers the following advantages:
Ensuring an approximately constant bending radius of the cable across its entire length. The elastic cable deformation is defined by the spring component. Overloading the cable is not possible when suitably rating the supporting spring.
Protection of the cable insulation. Should there be a contact between feed line and other components (caused, for example, by shocks of the compressor housing) the relatively soft insulation remains protected. The spring steel itself cannot be damaged by the surrounding components made of aluminium.

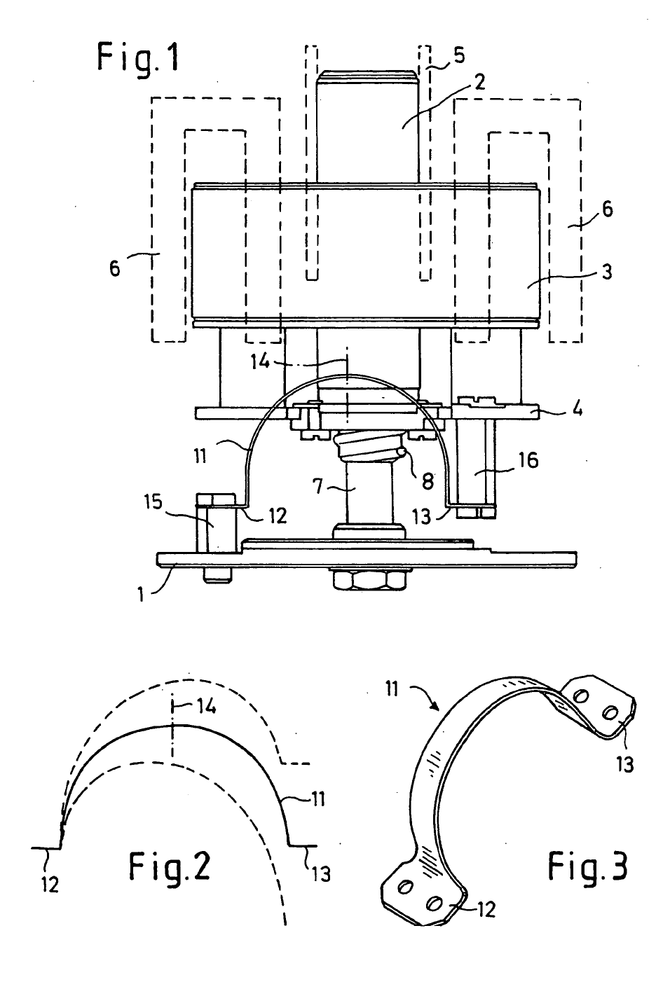

Further advantages and details of the present invention shall be explained with reference to the examples of embodiments depicted in part only schematically in drawing FIGS. 1 to 5. Depicted are in

drawing FIG. 1, components important to the present invention for a drive of the here affected kind, with a line section implemented by way of a copper strip between a fixed carrier and an oscillating coil,

drawing FIG. 2, motional states of the line section according to drawing FIG. 1,

drawing FIG. 3, a specific example of an embodiment for a current feeder according to drawing FIGS. 1, 2,

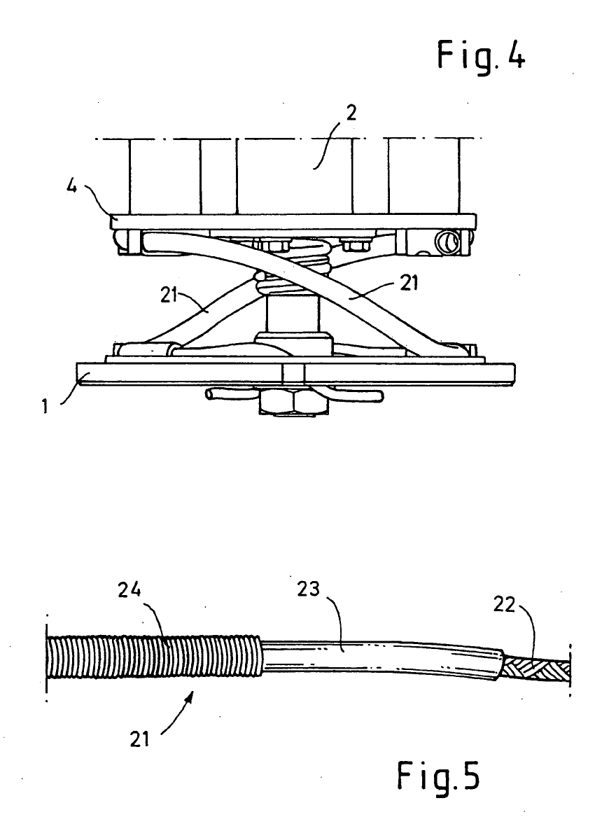

drawing FIG. 4, a second embodiment for a line section between a fixed support and an oscillating coil and

drawing FIG. 5, the design of the line section according to drawing FIG. 4.

In drawing FIG. 1, a fixed carrier component is designated as 1, the oscillating piston with 2, the oscillating coil with 3 and a carrier component supporting the oscillating piston 2 and the oscillating coil 3 is designated as 4. The cylinder 5 accepting the oscillating piston 2 and the magnet 6 related to the oscillating coil 3 are indicated by dashed lines.

A stub 7 in which the oscillating piston 2 is guided is joined to the fixed carrier component 1 for the purpose of guiding and providing resilient support for the oscillating system. A spiral spring 8 is supported in the oscillating piston 2 and at stub 7.

The piston 2 performs in cylinder 5 its oscillating linear motion effecting the production of low temperatures. It is known to arrange two oscillating pistons 2 working in opposite directions. Components of a cooling system of this kind are two of the units depicted in drawing FIG. 1 together with a joint cold section not depicted in drawing FIG. 1.

The oscillating coil 3 (respectively, each of the two oscillating coils of a cooling system with two oscillating pistons) requires a power supply with two electrical connections running from fixed carrier component 1 to oscillating coil 3. In drawing FIG. 1, for reasons of clarity, only one of these connections equipped with a flexible line section 11 in accordance with the present invention is depicted. The necessary second electrical connection can be designed in a similar manner. However, there also exists the possibility of employing cylinder 2, spring 8 and the stub 7 for the purpose of providing the second connection between the coil 3 and the base 1.

The flexible line section 11 consists of a bent copper strip, preferably bent in a semicircular fashion. It is equipped with terminating pieces 12, 13 bent radially towards the outside, serving the purpose of connecting the line section 11 to feed lines, respectively further lines not depicted. Expediently the line section 11 is in its semicircular bent shape at its rest position. In the instance of materials which after the bending process easily bend back, fitting under mechanical tension at the rest position can be of advantage. At these positions it is designed to be symmetrical. The axis of symmetry is designated as 14.

Installation of the line section 11 into the drive in accordance with drawing FIG. 1 is expediently selected such that the direction of the linear oscillation being performed by the oscillating end of the line section 11 is effected approximately in parallel to the axis of symmetry 14 and such that during the zero crossing of the oscillation, the line section 11 has its rest position. This state is depicted in drawing FIG. 1. Insulators 15 and 16 of a suitable size being supported by the carrier components 1 and 4 define the desired installation position. Expediently, at least one pin is fitted at the carrier component 1, said pin projecting into a bore in the carrier component 4 so that the moved unit cannot twist too much, thereby preventing possible short-circuits. Drawing FIG. 2 depicts three positions attainable by the line section 11 during the oscillations. The centre position corresponds to the rest position detailed. Upon reaching the maximum amplitude levels, the line section 11 reverts to the positions indicated in each instance by dashed lines.

Drawing FIG. 3 depicts a three-dimensional view of a specific example of an embodiment. It is manufactured of a copper panel 0.05 to 0.2 mm thick, preferably 0.1 mm thick. It has a width of 5 to 10 mm, preferably 7.5 mm and a length between 60 and 70 mm. At its end areas the strip widens. The angled terminal pieces 12 and 13 are parts of the wider end areas.

In the embodiment according to drawing FIG. 4, the carrier component 4 for the oscillating coil 3 is linked through line sections 21 to the fixed carrier component 1. Said line sections extend each in the shape of an arc of approximately 180° and at a relatively low slope (depending on the coil position in a range of approximately 5° to 30°) between their fixed points at the components 1, 4. The values of the bending radii of the feed wires are in the range of half of the diameter of the oscillating coils whereby the diameter of the oscillating coils is in the order of magnitude of 10 cm. The axes of symmetry of the arcs form with the oscillating direction of the coil 3 an angle of approximately 90°. In the area of the fixed points, the slope of the line sections passes into the respective plane of the components 1, 4.

As depicted in drawing 5, the line sections 21 exhibit a core 22 expediently made of a highly flexible copper mesh. A Teflon sheath 23 surrounds the core 22 and forms the electrical insulation. It in turn is surrounded by a support spring 24. Said support spring is expediently designed by way of a spiral spring made of steel. The ends of the support springs 24 serve also the purpose of affixing the two line sections 21 on the carrier components 1, 4.

1. A drive for a piston of a linear cooler, comprising:
a power supply for the coil including a flexible section of line running from a fixed support component to the oscillating coil, the line section including a bent strip of metal preferably of copper or copper alloy.

2. The drive according to claim 1, wherein the line section at its rest position has approximately the shape of a semicircle.

3. The drive according to claim 1, wherein the line section is equipped with terminating pieces bent radially towards the outside and made of a material compatible with the bending radius.

4. The drive according to claim 1, wherein the line section has widened end areas.

5. The drive according to claim 1, wherein an oscillating end of the line section oscillates linearly and parallel to an axis of symmetry of the line section.

6. The drive according to claim 1, wherein the line section has a rest position while passing through the zero crossing of the oscillation.

7. The drive according to claim 4 further including insulators at the carrier component and at the oscillating coil for defining an installation position of the line section.

8. The drive according to claim 1, wherein a copper-beryllium alloy.

9. A drive for the piston of a linear cooler, comprising:
a magnet;
a linear oscillation coil; and
a power supply for the coil with a flexible section of electric line running from a fixed support component to the oscillating coil, the line section including:
a central bore of electrically conducting material,
a plastic insulating sheath surrounding the core, and
a supporting component surrounding the sheath.

10. The drive according to claim 9, wherein the core includes a flexible copper mesh.

11. The drive according to claim 9, wherein the insulating sheath is polytetrafluoroethylene.

12. The drive according to claim 9, wherein the supporting component is a spiral spring.

13. The drive according to claim 9, wherein a bending radius of the line section corresponds to approximately half of the a diameter of the oscillating coil and a slope of said line section is between 5° and 30° and extends 25% to 50% around a circle.

14. The drive according to claim 9, further including:
a rotation lock for the oscillating coil and associated moving parts.

15. The drive according to claim 1, further including:
a rotation lock for the oscillating coil and associated moving parts.

16. A linear cooler incorporating the drive of claim 1.

17. A linear cooler piston drive assembly comprising:
a fixed support component;
a magnet mounted to the fixed support component;
a linear oscillation coil assembly mounted for oscillating movement relative to the fixed support component and the magnet;
at least one electrical power line section mounted at one end to the fixed support component and at an opposite end to the linear oscillation coil assembly, the electrical power line section including a mid-portion which at least one of:
extends in a semi-round shape between the ends, the semi-round shape having a central axis parallel to a direction of linear oscillation of the coil assembly, and
a flexible electrical conducting element insulated with flexible insulation, a spring supporting the electrically conducting element and controlling flexing movement thereof.

18. The drive according to claim 17 wherein the electrically conducting element is one of:
a flexible, electrically conductive mesh; and
a metal strip which is less than 0.2 mm thick.
